(19) United States
(12) Patent Application Publication
(10) Pub. No.: US 2023/0255136 A1
(43) Pub. Date: Aug. 17, 2023

(54) PLANTING SYSTEM FOR OPTIMIZATION OF PLANT GROWTH WITH DIRECT AIR INJECTION

(71) Applicant: Precision Cultivation Systems Holdings, LLC, Santa Ana, CA (US)

(72) Inventor: Kristopher Kaminski, Las Vegas, NV (US)

(21) Appl. No.: 17/674,567

(22) Filed: Feb. 17, 2022

(51) Int. Cl. A01C 7/00

(52) U.S. Cl. CPC A01C 7/004

(57) ABSTRACT

The present invention relates to a planting system including a container including a wall and a floor defining an internal volume and a grate located within the container and spaced apart from the floor for defining portions of the internal volume of the container above the grate and below the grate. The portion above the grate is for receiving planting medium wherein the grate is adapted for supporting the planting medium and roots of a plant planted therein. The portion below the grate is located between the grate and the floor of the container and is comprised of empty space. The plate includes a plurality of apertures that are adapted for allowing the roots of the plant to grow and to pass through the grate to the portion of the internal volume below the grate. The planting system includes an air supply device for providing a supply of air to the portion of the internal volume below the grate and to the roots passing through the grate and to the planting medium through the apertures in the grate.

### FIELD OF THE INVENTION

The present invention relates to the field of plant cultivation. More particularly, the disclosure relates to a planting system that includes plant containers and an irrigation system for optimizing plant growth or yield.

### BACKGROUND OF THE INVENTION

Plants are cultivated for a variety of purposes including for the production of food and fiber for human and animal consumption or for use in industrial processes. The cultivation of plants has traditionally involved growing plants in natural soil in the ground outdoors or in a growing medium in containers such as pots or planters.

In agriculture and horticulture, yield is a fundamental measurement of the amount of a crop that is grown and harvested for a given input such as area of land. In some settings, the cultivation of plants in containers such as pots or planters is desirable or necessary. The use of containers for plant cultivation has a number of benefits including better control over the growing medium or soil, minimizing impacts of parasites and weeds and better control over watering. The use of containers enables plants to be cultivated indoors where environmental factors including light, humidity, temperature and air composition can be controlled. Having greater control over the parameters that determine plant growth and yield enables a user to optimize these outcomes according to a set of objectives. Such objectives could include, for example maximizing yield, maximizing crop quality, controlling crop timing or growing crops outside of their native planting zone.

One of the functions of the growing medium is to serve as a site for air exchange between the root zone and the atmosphere. Different plants have different oxygen requirements for their root systems. Some plants have roots that require a lot of oxygen and thus may prefer a medium that is less dense or that has a lower water holding capacity whereas other plants have roots that may require less oxygen and may instead prefer a medium with a high water holding capacity. Accordingly, oxygen concentration in a growing medium can be determined by a variety of factors including water saturation, the composition of the medium and its density and even temperature.

Plants can have varying requirements for root oxygenation, water, light and other variables at different times. Accordingly, the yield of a crop may be controlled, and ideally maximized, by exercising precise control over root oxygenation, water, light and other variables at different times of the day or in different stages of plant development such as the vegetative stage and the flowering or fruition stage.

Nevertheless, plant containers can have drawbacks. Traditional pots or planters comprising hard-sided plastic or ceramic pots, typically having one or more drainage holes at the bottom, may not allow sufficient oxygen ingress into the growing medium in order to reach the roots. Such pots typically include a hard, non-breathable surface such as ceramic or plastic entirely enclosing, apart from the drainage holes, the lateral sides and the base of the growing medium. Such arrangements can result in overwatering, particularly if the drainage holes are under sized. Furthermore, plants that are cultivated in traditional pots or planters are prone to becoming root-bound, particularly if the pot or planter is not large enough.

Some of the problems associated with traditional planters are overcome by fabric planters having porous sides and bottoms that allow oxygen to reach, and water to drain away from, the roots of the plants in the planting medium. This allows the root tips to dehydrate, forcing the root tips to branch out and become more productive. However, because fabric planters increase the rate transpiration of the planting medium, water tends to evaporate quicker which speeds up plant metabolism, causing plants to require more water. Thus, plants being grown in fabric planters are prone to being underwatered.

Hybrid planters exist that combine the features of traditional, non-porous pots and with a porous fabric liner. However, drainage and oxygenation in these hybrid planters is still inadequate because the planting medium is still bound by the non-porous surface of the pot without any means of providing additional oxygen to the planting medium in the root zone. Furthermore, the roots of the plants eventually grow through the fabric liners and can spiral, twist, kink, or become strangled in the bottom and sides of the pot.

Irrigation is another consideration for existing pots and planters such as those mentioned above. Some pots and planters have a reservoir of water in direct contact with the planting medium and rely on capillary action or wicking to draw the water upwardly into the medium. However, in pots and planters that rely on wicking for watering the lower part of the planting medium is always saturated. As the lower parts of the roots specialize in feeding the constant, excess moisture can retard growth and cause root disease. Other pots and planters use drip systems in which a dripper is implanted in, or suspended over, the planting medium. The dripper may be in the form of a loop or ring having a number of drip holes formed along its length. However, existing drip loops or rings distribute water unevenly through the planting medium resulting in wet and dry zones.

Applicant's US2018132430 (A1) discloses a planting system for ameliorating some of the problems described above with existing pots and planters. The planting system includes a pot having a bottom floor with at least one drainage opening connected to a drainage pipe, a spray ring implanted in the planting medium in an upper portion of the pot and configured to inject pressurized water downwardly into the planting medium, and a grid disposed below the planting medium. The grid includes a plate spaced above the bottom floor of the pot. The plate includes apertures configured to allow roots to pass through the plate. Slats formed on the underside of the plate define a plurality of compartments configured to prevent the roots from spiraling. The bottom end of each of the slats is spaced above the floor of the pot. The grid also allows oxygen to circulate under and around the roots, prevent the roots from spiraling and wherein excess water is drained from the sump to maintain a space for air to circulate between the floor and the grid.

However, there exists a need for pots and planters that enable enhanced control over oxygenation of the planting medium, particularly in the root zone. There exists a need for pots and planters that enable enhanced control over oxygenation of the planting medium and that facilitates enhanced control over watering, effective draining of the planting medium and avoids saturation of roots for extended periods of time, allows oxygen to circulate around and under the roots and prevents the roots from spiraling.

Any discussion of background art throughout the specification should in no way be considered as an admission that any of the documents or other material referred to was published, known or forms part of the common general knowledge.

### SUMMARY OF THE INVENTION

Accordingly, in a first aspect, the invention provides a planting system including:

a container including a wall and a floor defining an internal volume;
a grate located within the container and spaced apart from the floor for defining portions of the internal volume of the container above the grate and below the grate, the portion above the grate for receiving planting medium wherein the grate is adapted for supporting the planting medium and roots of a plant planted therein, the portion below the grate being located between the grate and the floor of the container and being comprised of empty space, the plate including a plurality of apertures that are adapted for allowing the roots of the plant to grow and to pass through the grate to the portion of the internal volume below the grate;
an air supply device for providing a supply of air to the portion of the internal volume below the grate and to the roots passing through the grate and to the planting medium through the apertures in the grate.

Embodiments of the invention are advantageous in that they provide pots and planters that enable enhanced control over oxygenation of roots of plants and of the planting medium, particularly in the root zone. Embodiments of the invention are advantageous in that they facilitate enhanced control over watering, effective draining of the planting medium and avoiding saturation of roots for extended periods of time, allows oxygen to circulate around and under the roots and prevents the roots from spiraling.

Thus, the roots that have passed through the plate are supplied with oxygen to increase plant metabolic rates and fruit yield. Also, some air exchange occurs between the chamber and the planting medium through the apertures in the plate to enable oxygen to reach roots that are embedded in the medium. As a plant actively metabolizes oxygen through the roots, the air supply device, with an attached air pump, allows a user to mitigate the natural depletion of oxygen within the cavity located under the grate. Supplementation of air to the cavity prevents significant depletion of oxygen levels within said cavity allowing the user to maintain a desired level of oxygen to the root zone of the plant. In addition, the direct supplementation of air under the planting medium within the air void works to mitigate depleted oxygen levels within the planting medium.

In embodiments, the air supply device includes at least one air conduit extending through the floor of the container including an air outlet at an end of the air conduit located within the internal volume of the container.

In embodiments, the air outlet includes an adjustable air outlet opening for controlling the flow of air out of the air outlet and into the internal volume of the container.

Preferably, the air outlet includes a first fitting coupled directly to the air conduit and a second fitting coupled to the first fitting. Preferably, the first fitting includes one or more of the air outlet openings and the second fitting is movable relative to the first fitting to selectively cover a proportion of the one or more air outlet openings and thereby adjust the air outlet opening.

In embodiments, the first fitting and the second fitting are adapted for progressively adjusting the proportion of the one or more air outlet openings that are covered.

Preferably, the first fitting and the second fitting are threadedly coupled together.

Preferably, the first fitting includes a longitudinal body having a central, longitudinal passage and a plurality of the air outlet openings located laterally to and in fluid communication with the longitudinal passage.

In embodiments, the second fitting includes an annular body that surrounds the longitudinal body of the first fitting and the lateral air outlet openings thereof, wherein a longitudinally extending annular channel is defined between the annular body and the lateral air outlet openings for redirecting air exiting laterally therefrom in a longitudinal direction.

In embodiments, the air conduit is connected to a supply of air for providing fluid communication between the supply of air and the internal volume of the container.

Preferably, the air conduit is coupled to an air duct that extends horizontally beneath the floor of a plurality of the containers and to the air supply.

Preferably, the air supply includes an air pump for pumping air at a predetermined rate and/or pressure through the air duct. In embodiments, the air supply may also be configured to apply a vacuum to thereby draw air into the planting medium from the surrounding air. In embodiments, the air supply includes a compressed air source or a pure oxygen source under pressure to fill the portion of the internal volume below the grate with air or pure oxygen.

In embodiments, the floor includes at least one drainage opening for directing excess water out of the pot.

Preferably, the floor includes a longitudinal drainage channel extending transversely across the floor towards opposite sides thereof that operates as a sump for collecting the excess water and for channeling the water to the at least one drainage opening.

Preferably, the at least one drainage opening is open at the lowest level of the drainage channel for draining away any standing water from the drainage channel.

In embodiments, the drainage opening is coupled to a drainage duct that extends horizontally beneath the floor of a plurality of the containers and to a water supply.

In embodiments, wherein a plurality of slats extend downwardly from the grate and are connected with each other to create a plurality of air compartments between the floor and the grate.

Preferably, the bottom of the slats are spaced apart from the floor for air to circulate relative to the air compartments.

In embodiments, a supporting base is coupled to the container for supporting the container above ground level and for providing a space between the floor of the container and the ground. Preferably, the supporting base is configured to elevate the container above the supporting surface to provide room for elongated, downwardly extending drainage lines to extend therefrom by a length sufficient to establish gravity assisted drainage from the pot.

Preferably, a permeable liner is located within the container above the grid and the planting medium is contained within the liner.

In embodiments, the planting system includes an irrigation assembly including a water spray device positioned above the planting medium within the container, wherein the spray device is connected to a water conduit that is in fluid communication with a water supply for supplying water to be sprayed by the spray device onto the planting medium.

In another aspect, the invention provides a horticultural method including:

providing a container including a wall and a floor defining an internal volume;
providing a grate within the container that is spaced apart from the floor for defining a portion of the internal volume of the container above the grate;
providing a planting medium in the portion of the internal volume of the container above the grate, wherein the grate supports the planting medium and roots of a plant planted therein and has a plurality of apertures that are adapted for allowing the roots of the plant to grow and to pass through the grid; and
providing a supply of air to a portion of the internal volume of the container between the floor and the grate and thereby providing air to the roots passing through the grid and to the planting medium through the apertures in the grid.

In embodiments, the method includes controlling a flow of air out of the air outlet and into the internal volume of the container.

Preferably, the method includes adjusting an air outlet opening for controlling the flow of air out of the air outlet and into the internal volume of the container.

In preferred embodiments, the method includes irrigating the planting medium for a predetermined period of time and draining excess water that passes through the floor includes at least one drainage opening for directing excess water out of the pot.

### BRIEF DESCRIPTION OF THE DRAWINGS

The present invention will now be described in more detail with reference to preferred embodiments illustrated in the accompanying figures, wherein:

FIG. 1 is a perspective view of a pot and supporting base of a planting system according to the present disclosure.

FIG. 2 is an exploded view from a perspective above of the pot and supporting base of FIG. 1, including a container, a grate locatable in the container, an air conduit for extending through the center of the floor of the container, an air outlet at an end of the air conduit, a supporting base for the container, a fitting for threaded connection with the conduit for coupling the base and the container together and a water spray device for positioning above the planting medium within the container.

FIG. 3 is an exploded view from a perspective below of the pot and supporting base of FIG. 1.

FIG. 4 is an exploded view from a side perspective of the pot and supporting base of FIG. 1.

FIG. 5 is a plan view of the pot and supporting base of the planting system of FIG. 1.

FIG. 6 is a section view of the pot and supporting base of the planting system of FIG. 1 taken through section line A-A of FIG. 5, including an air conduit extending through the center of the floor of the container and an air outlet at an end of the air conduit located within the internal volume of the container, wherein a transverse section is shown of a longitudinal drainage channel that extends transversely across the floor of the container for collecting the excess water and for channeling the water to at least one drainage opening.

FIG. 7 is an enlarged view of part B of the section view of the pot and supporting base of FIG. 6.

FIG. 8 is a plan view of the pot and supporting base of FIG. 1.

FIG. 9 is a section view of the pot and supporting base of the planting system of FIG. 1 taken through section line C-C of FIG. 8, including the air conduit extending through the center of the floor of the container and the air outlet at the end of the air conduit located within the internal volume of the container, wherein a longitudinal section is shown of the longitudinal drainage channel that extends transversely across the floor of the container for collecting the excess water and for channeling the water to drainage openings located at longitudinally opposite ends of the drainage channel.

FIG. 10 is a perspective view of the air conduit of the embodiments of the planting system of FIGS. 1, 5 and 8;

FIG. 11 is a side view of the air conduit of FIG. 10;

FIG. 12 is a section view of the air conduit of FIG. 10 taken through section line D-D of FIG. 11.

FIG. 13 is a perspective view of the air outlet of the embodiments of the planting system of FIGS. 1, 5 and 8;

FIG. 14 is an exploded view of the air outlet of FIG. 13,

FIG. 15 is a plan view of the air outlet of FIG. 13;

FIG. 16 is a side view of the air outlet of FIG. 13;

FIG. 17 is a section view of the air outlet of FIG. 13 taken through section line E-E of FIG. 16;

FIG. 18 is a side view of the air outlet of FIG. 13.

### DETAILED DESCRIPTION

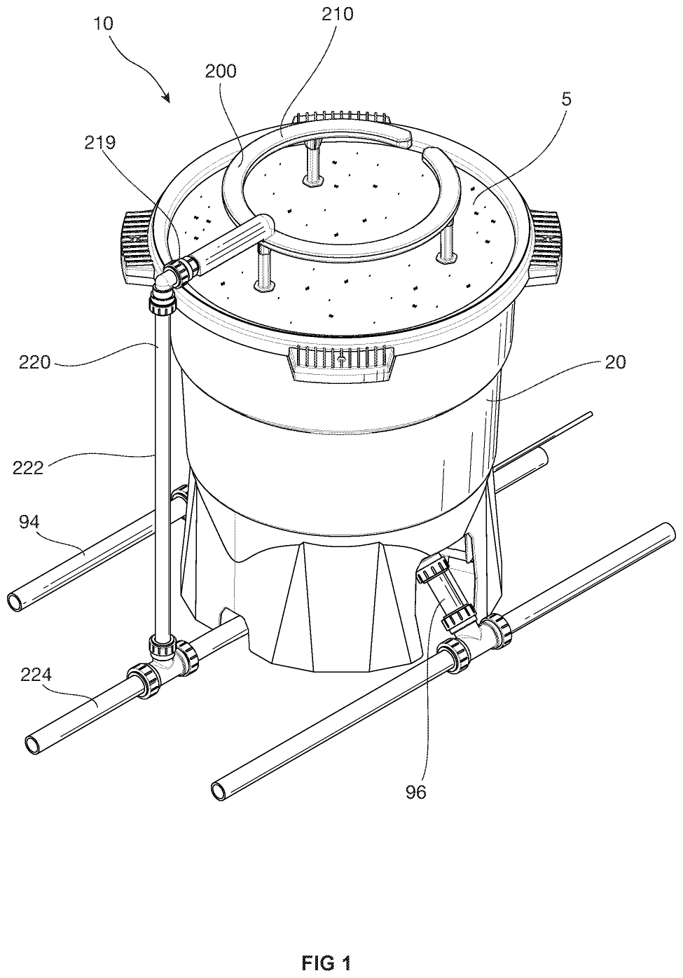

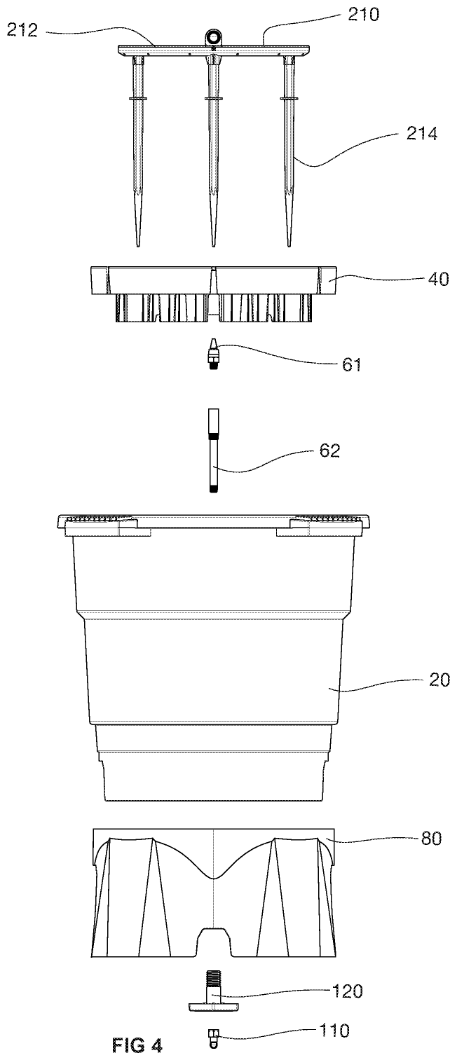

Referring to FIGS. 1 to 4, there is shown a planting system 10 in accordance with an embodiment of the present invention. The planting system 10 includes a container 20 including a wall 22 and a floor 30 defining an internal volume 24. A grate 40 is located within the container 20 and is spaced apart from the floor 30 for defining a portion of the internal volume 24 of the container above the grate 40 for receiving planting medium 5. The grate 40 is adapted for supporting the planting medium 5 and roots of a plant planted therein and having a plurality of apertures 44 that are adapted for allowing the roots of the plant to grow and to pass through the grate 40. The planting system 10 further includes an air supply device 60 for providing a supply of air to a portion of the internal volume 24 of the container 20 between the floor 30 and the grate 40 and to the roots passing through the grate 40 and to the planting medium 5 through the apertures 44 in the grate 40.

The container 20 is generally in the form of a pot. The wall 22 is generally cylindrical and upstands from the peripheral edge of the circular shaped floor 30. The wall 22 has an outwardly extending rim 24 formed at its upper end. A set of radially extending gripping handles 25 are provided about the rim 24.

The side wall 22 of the container 20 has an upper side wall portion 23, an intermediate side wall portion 25 and a lower side wall portion 27. An annular ledge 26 joins the upper side wall portion 23 to the intermediate side wall portion 25 at an angle of about 45° to the horizontal. An annular shoulder 28 joins the intermediate side wall portion 25 to the lower side wall portion 27.

The planting system 10 includes a supporting base 80 for receiving and supporting the bottom of the container 20. The supporting base 80 is an annular member having open upper and lower ends 82, 86. A slightly tapered side wall 84 extends between the upper end 82 and the lower end 86. The side wall 84 includes a pair of opposite large openings 81, 83 that allow drainage ducts 94, 96 to pass through. Both the container 20 and the supporting base 80 may be made from molded, preferably injection molded, thermoplastic material. Preferably, the container 20, the grate 40 and the support base 80 are made from acrylonitrile butadiene styrene (ABS) or high-density polyethylene (HDPE) or combination thereof.

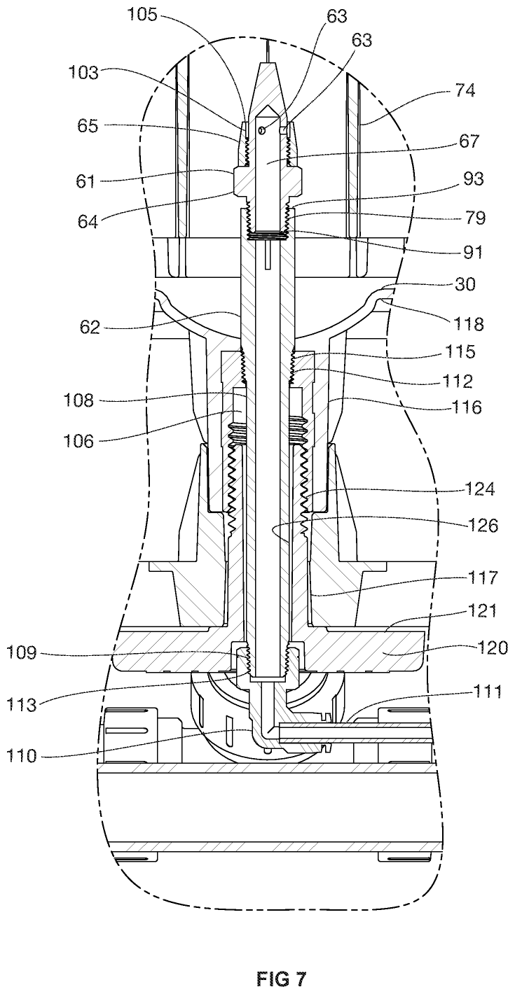

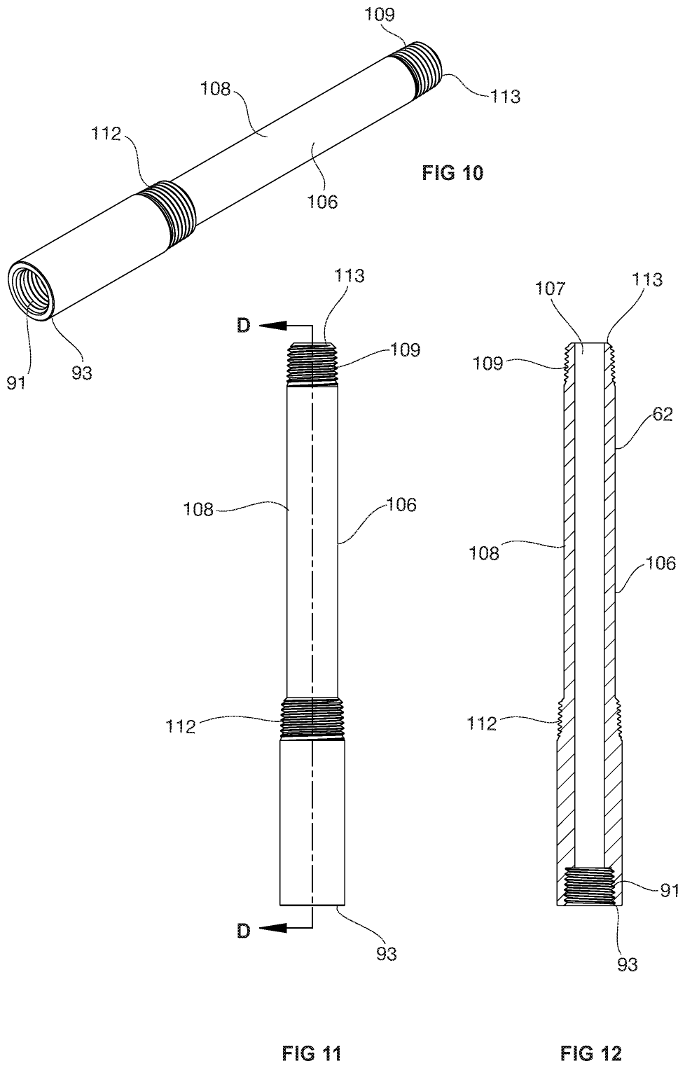

FIG. 7 illustrates a cross section of the assembled air supply device 60 and FIGS. 10 to 17 illustrate the air conduit 62 and the air outlet 61 in detail. The air supply device 60 includes at least one air conduit 62 extending through the floor 30 of the container 20. The portion of the internal volume 24 of the container 20 between the floor 30 and the grate 40 defines a chamber 70 comprised of an empty space into which the air supply device 60 supplies air in order to circulate freely below the grate 40. The air supply device 60 includes an air outlet 61 at an end of the air conduit 62 located within the chamber 70. The air outlet 61 includes an adjustable air outlet opening 63 for controlling the flow of air out of the air outlet and into the chamber 70 within the internal volume 24 of the container 20.

The air outlet 61 includes a first fitting 64 coupled directly to the air conduit 62 and a second fitting 65 adapted to be coupled to the first fitting 64. The first fitting 64 includes a longitudinal body 66 having a central, longitudinal passage 67 and a plurality of the air outlet openings 63 located laterally to and in fluid communication with the longitudinal passage 67. The longitudinal passage 67 of the first fitting 64 is also in fluid communication with the air conduit 62.

The longitudinal body 66 of the first fitting 64 has a lower portion 68 that has a generally cylindrical outer surface with a nut-shaped intermediate portion 73. The longitudinal body 66 has an upper portion 69 that has a generally conical form wherein the outer surface tapers to an apex 71. The outer surface of the lower portion 68 has an upper external threaded portion 77 and a lower external threaded portion 79. The lower external threaded portion 79 is for threaded connection with an internal thread 91 at the upper end 93 of the air conduit 62. The nut shaped intermediate portion 73 enables use of a spanner to tighten the first fitting 64 to the air conduit 62. As illustrated in FIGS. 14 and 17, the plurality of the air outlet openings 63 are located within a cylindrical external surface portion 78 between the upper external threaded portion 77 and the tapered upper portion 69 of the first fitting 64.

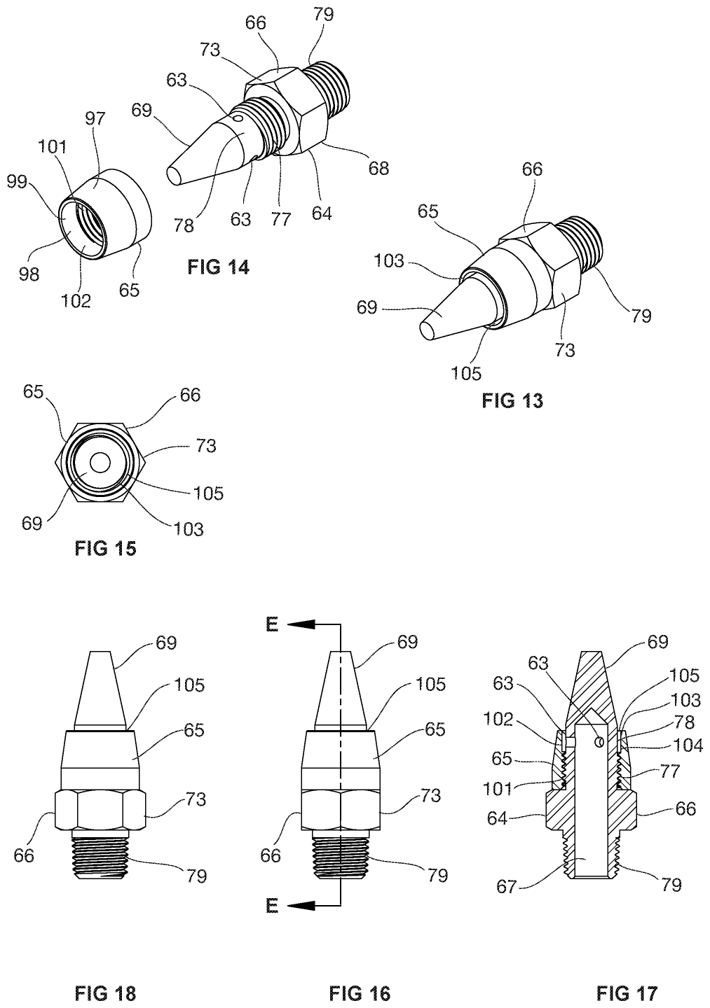

The second fitting 65 is comprised of an annular shaped member 97 comprising a central longitudinal passage 98 defined by a cylindrical inner surface 99. The inner surface 99 has an inner threaded portion 101 at one end and a smooth portion 102 at the other end. As illustrated in FIGS. 13 to 17, the inner threaded portion 101 is adapted for threaded connection with the external upper threaded portion 77 of the first fitting 64. When the second fitting 65 is threadedly connected with the first fitting 64 the smooth portion 102 of the inner surface 99 of the second fitting surrounds 65 and is spaced apart from the cylindrical external surface portion 78 of the first fitting 64. The inner surface 99 of the second fitting 65, the cylindrical external surface portion 78 of the first fitting 64 define opposite side walls of an annular channel 103 therebetween. The inner threaded portion 101 of the second fitting 65 defines a base 104 of the annular channel 103. The annular channel 103 has an opening 105 at an end opposite to the base 104.

As illustrated in FIG. 17, the plurality of the air outlet openings 63 of the first fitting 64 open into the annular channel 103. Air that exits laterally from the air outlet openings 63 is redirected out the open end 105 of the annular channel 103 and in a longitudinal direction. As illustrated in the Figures, the air outlet 61, comprising the first fitting 64 and the second fitting 65, are arranged vertically and the air that exits the air outlet openings 63 is also channeled vertically towards the bottom surface 43 of the grate 40. The air is able to circulate freely below the grate 40.

Relative rotation of the threadedly coupled second fitting 65 and first fitting 64 causes the second fitting 65 to progressively translate longitudinally relative to the first fitting 64. Translation of the second fitting 65 in a longitudinally upwards direction causes the inner threaded portion 101 of the second fitting 65 to progressively cover part of the one or more air outlet openings 63. Translation of the second fitting 65 in a longitudinally downwards direction causes the inner threaded portion 101 of the second fitting 65 to progressively uncover part of the one or more air outlet openings 63. Thus, the second fitting 65 is movable relative to the first fitting 64 to selectively cover a proportion of the one or more air outlet openings 63 and thereby adjust the air outlet opening 63.

The air conduit 62 includes a conduit body 106 having the form of an elongated pipe comprising a central longitudinal passage 107. The internal thread 91 for connection with the first fitting 64 is at one end of the longitudinal passage 107. An external surface 108 of the conduit body 106 includes a first threaded portion 109 at an end 113 opposite to the upper end 93 comprising the internal thread 91. The first threaded portion 109 is for threaded connection with an elbow fitting 110 which in turn is connected to an air supply line 111 or duct that extends horizontally beneath the floor of a plurality of the containers 20 to the air supply. The air supply line 111 is connected to a supply of air such as a compressed air source or an air pump. Air supply lines 111 from a plurality of the containers 20 can be connected in parallel or in series to the supply of air. In embodiments, the air supply may also be configured to apply a vacuum to thereby draw air into the planting medium 5 from the surrounding air. In embodiments, the air supply includes a compressed air source or a pure oxygen source under pressure to fill the portion of the internal volume below the grate with air or pure oxygen.

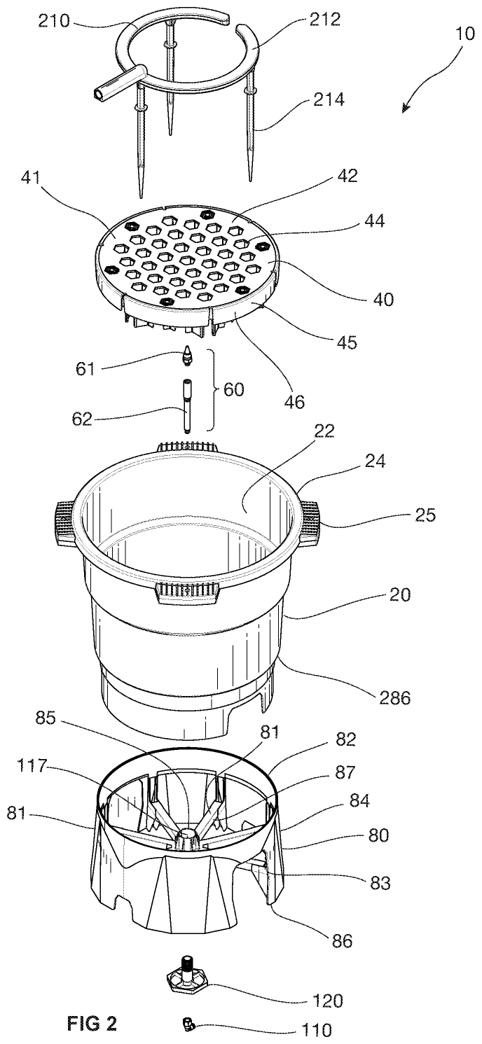

The external surface 108 of the conduit body 106 includes a second threaded portion 112 located intermediate the ends thereof. The second threaded portion 112 is adapted for threaded connection with a threaded opening 115 within the floor 30 of the container 20. As illustrated in the embodiment of FIGS. 2, 3, 4, 8 and 9, the threaded opening 115 is contained within a boss 116 protruding from the bottom surface 118 of the floor 30. The boss 116 is adapted to be aligned with a central aperture 117 in the supporting base 80 when the container 20 received within the supporting base 80. The first threaded portion 109 passes through the central aperture 117 for threaded connection with the elbow fitting 110 thereby locking the container 20 and the supporting base 80 together.

The air conduit 62 is connected to a supply of air such as a compressed air source or an air pump. The air conduit 62 providing fluid communication between the supply of air and the internal volume of the container. The air supply includes an air pump for pumping air at a predetermined rate and/or pressure through the air duct.

The grate 40 includes a plate 42 having a top surface 41 and a bottom surface 43. An annular band 45 depends downwardly from a peripheral edge of the plate 42. A plurality of apertures 44 extend through the top and bottom surfaces 41, 43 of the plate 42. The apertures 44 are sized and configured to allow roots of a plant in the planting medium to grow and to pass through the plate 42. Preferably the apertures 44 are hexagonal, however, in other embodiments the apertures 44 are circular, square or octagonal.

An internal, upwardly facing surface 28a of the annular shoulder 28 is adapted to abut with and to support a bottom edge of the annular band 45 when the grate 40 is placed within the container 20. Thus, the annular shoulder 28 supports the grate 40 and thereby maintains the plate 42 spaced apart from and above the floor 30 of the container 20.

An external, downwardly facing surface 28b of the annular shoulder 28 is adapted to abut with the upper end 82 of the side wall 84 of the support base 80 when the container 20 is inserted into the open upper end 82 of the support base 80 as shown in FIG. 1.

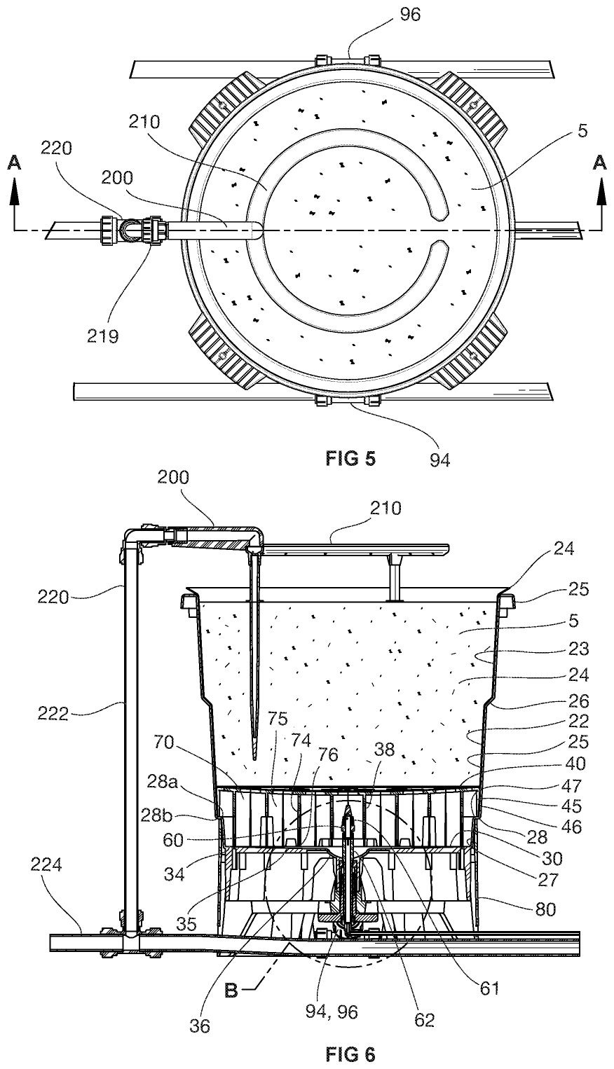

In the embodiment of FIGS. 1 to 4, the plate 42 is planar whereas in the embodiments of FIGS. 5 to 7 and FIGS. 8 and 9 the plate 42 is slightly concave and thereby slopes slightly downwardly toward the center of the plate 42. In FIGS. 1 to 4, the plate 42 has plurality of small openings on its edge to drain excess water on the sides or edge of plate. In the illustrated embodiments, the container is configured to contain approximately 105 liters of planting medium. The plate 42 has a diameter of about 55 centimeters (i.e. about 22 inches) and slopes downwardly in a continuous arc having a radius of curvature of about 295 centimeters (i.e. about 116 inches). The concavity of the plate 42 directs water inwardly toward the center of the plate 42 where it passes through the apertures 44.

Referring to FIGS. 5 to 9, the floor 30 of the container 20 is comprised of an outer peripheral floor portion 34 that extends substantially perpendicularly to the lower side wall portion 27. A central part of the floor 30 is comprised of a generally round or disc shaped intermediate floor portion 35 that has a slight fall towards a narrow drainage channel 36 that is sunken below the level of the intermediate portion 35. The intermediate floor portion 35 and channel 36 are adjoined to one another by a curved transition portion 38.

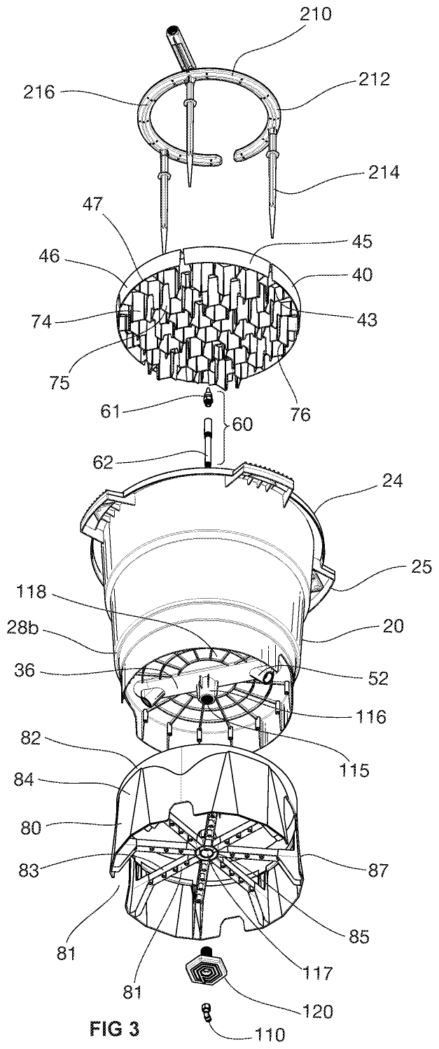

Accordingly, FIG. 6 illustrates a transverse cross section of the container 20 and the channel 36, which has a concave and semi-circular transverse cross section, and opposite halves of the slightly falling intermediate floor portion 35 separated by the channel 36. FIG. 9 illustrates a longitudinal cross section of the container 20 and the channel 36 which shows the longitudinal extent of the channel 36. FIG. 9 also illustrates the channel 36 extending to transversely opposite sides of the floor 30 of the container 20. FIG. 3 illustrates the bottom surface 118 of the floor 30 of the container 20 and the transverse channel 36 protruding downwardly therefrom.

A pair of drainage openings 50 are formed within the longitudinally opposite ends of the channel 36. The each one of the drainage openings 50 is in fluid communication with a drainage line fitting 52 that is formed integrally with the bottom surface 118 of the floor 30 of the container 20. The drainage line fitting 52 is integrally formed into the outer, bottom surface of the drainage channel 36 as illustrated in FIG. 3. As illustrated in FIG. 9, the drainage line fittings 52 are adapted for connection with the drainage ducts 94, 96 to fluidly connect the drainage openings 50 to the drainage ducts 94, 96, which extend horizontally beneath the floor of a plurality of the containers 20 and to a water supply. The drainage ducts 94, 96 extend downwardly at a decline from the floor 30 of the container 20 at an angle of approximately 45 degrees.

The base 80 is operable to elevate the floor 30 of the container 20 above the supporting surface to provide room for the drainage line fittings 52 and the drainage ducts 94, 96 to extend downwardly from the floor 30 of the container 20. The drainage of water from the drainage channel 36 and into the drainage ducts 94, 96 is assisted by gravity. The gravity assisted drainage is facilitated by the length of the drainage ducts 94, 96 extending downwardly from the floor 30 of the container 20. Accordingly, the elevation of the floor 30 of the container 20 above the supporting surface enables drainage ducts 94, 96 of sufficient length to establish gravity assisted drainage from the drainage channel 36.

The drainage channel 36 functions as a sump for collecting excess water that passes from the planting medium 5 and through the apertures 45 in the grate 40. The intermediate floor portion 35, which has a slight fall of between about 1 and 5 degrees, directs water into the drainage channel 36. The channel 36 collects the excess water and directs the water to the drainage openings 50. The drainage openings 50 are open at the lowest level of the floor 30 of the container, namely at the level of the base of the channel 36, for draining away any standing water from the floor 30 of the container 20. The intermediate floor portion 35, the drainage channel 36 and the drainage openings 50 are operable to drain away completely all water from the floor 30.

The air conduit 62 projects from within the channel 34 within the floor 30. The air outlet 61, comprising the first and second fittings 64, 65, is coupled directly to the upper end of the air conduit 62 protruding out of the channel 36. In the embodiments of the Figures, the air outlet 61 is spaced apart and above the channel 36 and above the level of the adjacent intermediate floor portion 34 to ensure that the air outlet is well above the level of any standing water on the floor 30 of the container 20.

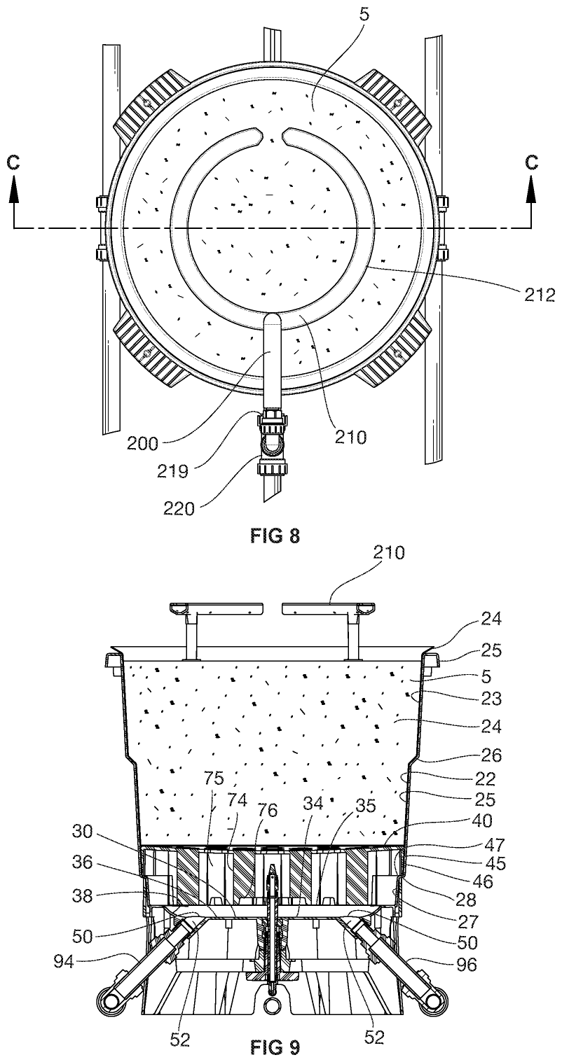

In FIGS. 1 to 6, 8 and 9, there is shown an irrigation assembly 200 including a water spray device 210 that is adapted to be positioned above the planting medium 5 within the container 20. The spray device 210 is connected to a water conduit 220 that is in fluid communication with a water supply for supplying water to be sprayed by the spray device 210 onto the planting medium 5. FIGS. 6 and 8 are sectional views showing the spray device 210 embedded in the planting medium 5. The spray device 210 includes a hollow, ring-shaped member 212 including a plurality of legs 214 depending downwardly therefrom. The ring-shaped member 212 includes a plurality of downwardly facing openings 216 configured to eject pressurized water into the planting medium 5. The spray device 210 may both be formed from a rugged plastic material such as ABS. The spray device 210 includes an inlet section 218 that extends horizontally beyond the edge of the container 20 at which there is a fitting 219 for connection to the water conduit 220. The water conduit 220 includes an assembly of pipes 222, 224 and fittings for connection to a source of pressurized water.

The plate 42 of the grate 40 maintained spaced apart from the floor 30 of the container 20 by the band 45 which is supported on the upwardly facing surface 28a of the annular shoulder 28 within the container 20. The band 45 is comprised of a downwardly extending peripheral side wall 46 that lies flush against the intermediate side wall portion 25 of the container 20. The band 45 also has a bottom edge 47 that abuts against the upwardly facing surface 28a of the annular shoulder 28 when inserted into the container 20 as shown in FIG. 9.

The space between the grate 40 and the floor 30 defines a chamber 70 comprised of an empty space into which air is supplied in order to circulate freely below the plate 42. Thus, the roots that have passed through the plate 42 are supplied with oxygen to increase plant metabolic rates and fruit yield. Also, some air exchange occurs between the chamber 70 and the planting medium 5 through the apertures 44 in the plate 42 to enable oxygen to reach roots that are embedded in the medium 5.

The fit between the side wall 46 of the band 45 and the intermediate side wall portion 25 of the container 20 is preferably tight enough to prevent substantial water passage therebetween. However, in some embodiments, the fit may be relatively loose to enable ease of removal of the grate 40 from the container 20.

A plurality of intersecting slats 74 extend downwardly from the bottom surface 43 of the plate 42. Each slat 74 has a bottom end 76 that is vertically spaced from the sunken central portion 36 of the floor 30 of the container 20. The slats 74 provide rigidity and structural support to the plate 42 and also divide the chamber 70 below the plate 42 into separate compartments 75 that prevent roots that have grown through the plate 42 from spiraling. In the illustrated embodiments, the compartments 75 are hexagonal-shaped and circumscribe a respective one of the apertures 44 in the plate 42. This allows the roots to commingle, while preventing them from becoming strangled at the bottom of the container 20. The bottom end 76 of the slats 74 are spaced apart from the floor 30 for air to circulate between the compartments 75.

### Supporting Base

The supporting base 80 includes a frame 81 located inside the side wall 84. The frame 81 is comprised of arms 87 that radiate outwardly from a centrally located casing 85 containing the central aperture 117. The arms 87 extend to and are integral with an inwardly facing surface of the sidewall 84 of the supporting base 80. When the container 20 is received within the supporting base 80 the boss 116 comes into contact with the casing 85 and is aligned with a central aperture 117 therewithin. As mentioned above, the first threaded portion 109 of the air supply conduit 62 passes through the threaded opening 115 within the boss 116 and through the central aperture 117 within the casing 85 for threaded connection with the elbow fitting 110, which thereby locks the container 20 and the supporting base 80 together.

A threaded fitting 120 is also fitted within the central aperture 117 of the supporting base 80. The threaded fitting 120 includes a base plate 121 and an externally threaded boss 124 upstanding from the base plate 121. The externally threaded boss 124 threadedly engages with the threaded opening 115 contained within the boss 116 protruding from the bottom surface 118 of the floor 30 of the container 20. The threaded fitting 120 is operable to further secure the container 20 together with the supporting base 80. The threaded fitting includes a longitudinal passage 126 through which the lower end 113 of the conduit body 106 passes through for the first threaded portion 109 thereof to connect with the elbow fitting 110.

As previously mentioned, all the parts in the disclosed planting system may be made from acrylonitrile butadiene styrene (ABS) or high-density polyethylene (HDPE) or a combination thereof.

According to the present disclosure there is further provided a horticultural method for enhancing plant growth using the planting system or assembly illustrated in the Figures. The method comprises and initial step of providing a container including a wall and a floor defining an internal volume. A grate is provided within the container that is spaced apart from the floor for defining a portion of the internal volume of the container above the grate. The method further includes providing a planting medium in the portion of the internal volume of the container above the grate, wherein the grate supports the planting medium and roots of a plant planted therein and has a plurality of apertures that are adapted for allowing the roots of the plant to grow and to pass through the grid. The method further includes providing a supply of air to a portion of the internal volume of the container between the floor and the grate and thereby providing air to the roots passing through the grid and to the planting medium through the apertures in the grid.

Preferably, the planting medium is placed into the container and optionally a liner is placed between the planting medium and the container so the space above the grid is fully or partially filled with the planting medium. The method can further include planting a plant or plants into the planting medium. Using the disclosed planting system, the roots of the plant will grow through the grate into the plurality of compartments, where they can receive more air than a conventional planting system, thereby enhancing the plant's growth.

In embodiments, the method includes a step of controlling a flow of air out of the air outlet and into the internal volume of the container. Preferably, the method includes adjusting an air outlet opening for controlling the flow of air out of the air outlet and into the internal volume of the container.

In embodiments, the method includes irrigating the planting medium for a predetermined period of time and draining excess water that passes through the floor includes at least one drainage opening for directing excess water out of the pot.

The method may further comprise the step of placing a spray device in the planting medium, such as by inserting legs of the spray device into the planting medium, as shown in FIGS. 1, 5, 6, 8 and 8, or by connecting the spray device to an upper edge of the container. The spray device may receive water from a water supply that runs beneath and pass through the base of the planting system. Multiple planting systems can also be used and connected in series at the same time through the same water supply pipe and drainage conduits.

1. A planting system including:
a container including a wall and a floor defining an internal volume;
a grate located within the container and spaced apart from the floor for defining portions of the internal volume of the container above the grate and below the grate, the portion above the grate for receiving planting medium wherein the grate is adapted for supporting the planting medium and roots of a plant planted therein, the portion below the grate being located between the grate and the floor of the container and being comprised of empty space, the plate including a plurality of apertures that are adapted for allowing the roots of the plant to grow and to pass through the grate to the portion of the internal volume below the grate;
an air supply device for providing a supply of air to the portion of the internal volume below the grate and to the roots passing through the grate and to the planting medium through the apertures in the grate.

2. The planting system of claim 1, wherein the air supply device includes at least one air conduit extending through the floor of the container including an air outlet at an end of the air conduit located within the internal volume of the container.

3. The planting system of claim 2, wherein the air outlet includes an adjustable air outlet opening for controlling the flow of air out of the air outlet and into the internal volume of the container.

4. The planting system of claim 3, wherein the air outlet includes a first fitting coupled directly to the air conduit and a second fitting coupled to the first fitting.

5. The planting system of claim 4, wherein the first fitting includes one or more of the air outlet openings and the second fitting is movable relative to the first fitting to selectively cover a proportion of the one or more air outlet openings and thereby adjust the air outlet opening.

6. The planting system of claim 5, wherein the first fitting and the second fitting are adapted for progressively adjusting the proportion of the one or more air outlet openings that are covered.

7. The planting system of claim 5 or claim 6, wherein the first fitting and the second fitting are threadedly coupled together.

8. The planting system of claim 5, wherein the first fitting includes a longitudinal body having a central, longitudinal passage and a plurality of the air outlet openings located laterally to and in fluid communication with the longitudinal passage.

9. The planting system of claim 8, wherein the second fitting includes an annular body that surrounds the longitudinal body of the first fitting and the lateral air outlet openings thereof, wherein a longitudinally extending annular channel is defined between the annular body and the lateral air outlet openings for redirecting air exiting laterally therefrom in a longitudinal direction.

10. The planting system of claim 2, wherein the air conduit is connected to a supply of air for providing fluid communication between the supply of air and the internal volume of the container.

11. The planting system of claim 10, wherein the air conduit is coupled to an air duct that extends horizontally beneath the floor of a plurality of the containers and to the air supply.

12. The planting system of claim 11, wherein the air supply includes an air pump for pumping air at a predetermined rate and/or pressure through the air duct.

13. The planting system of claim 1, wherein the floor includes at least one drainage opening for directing excess water out of the pot.

14. The planting system of claim 13, wherein the floor includes a longitudinal drainage channel extending transversely across the floor towards opposite sides thereof that operates as a sump for collecting the excess water and for channeling the water to the at least one drainage opening.

15. The planting system of claim 14, wherein the at least one drainage opening is open at the lowest level of the drainage channel for draining away any standing water from the channel.

16. The planting system of claim 15, wherein the drainage opening is coupled to a drainage duct that extends horizontally beneath the floor of a plurality of the containers and to a water supply.

17. The planting system of claim 1, wherein a plurality of slats extend downwardly from the grate and are connected with each other to create a plurality of air filled compartments between the floor and the grate.

18. The planting system of claim 17, wherein the bottom of the slats are spaced apart from the floor for air to circulate relative to the air compartments.

19. The planting system of claim 1, wherein a supporting base is coupled to the container for supporting the container above ground level and for providing a space between the floor of the container and the ground.

20. The planting system of claim 19, wherein the supporting base is configured to elevate the container above the supporting surface to provide room for elongated, downwardly extending drainage lines to extend therefrom by a length sufficient to establish gravity assisted drainage from the pot

21. The planting system of claim 1, wherein a permeable fabric liner is located within the container above the grid and the planting medium is contained within the liner.

22. The planting system of claim 1, including an irrigation assembly including a water spray device positioned above the planting medium within the container, wherein the spray device is connected to a water conduit that is in fluid communication with a water supply for supplying water to be sprayed by the spray device onto the planting medium.

23. A horticultural method including:
providing a container including a wall and a floor defining an internal volume;
providing a grate within the container that is spaced apart from the floor for defining a portion of the internal volume of the container above the grate;
providing a planting medium in the portion of the internal volume of the container above the grate, wherein the grate supports the planting medium and roots of a plant planted therein and has a plurality of apertures that are adapted for allowing the roots of the plant to grow and to pass through the grid;
providing a supply of air to a portion of the internal volume of the container between the floor and the grate and thereby providing air to the roots passing through the grid and to the planting medium through the apertures in the grid.

24. The method of claim 23, including controlling a flow of air out of the air outlet and into the internal volume of the container.

25. The method of claim 23, including adjusting an air outlet opening for controlling the flow of air out of the air outlet and into the internal volume of the container.

26. The method of claim 23, including irrigating the planting medium for a predetermined period of time and draining excess water that passes through the floor includes at least one drainage opening for directing excess water out of the pot.
